(19) United States
(12) Patent Application Publication
(10) Pub. No.: US 2011/0214159 A1
(43) Pub. Date: Sep. 1, 2011

(54) COMPUTER SYSTEM

(75) Inventor: Keiichi Kuroda, Yokohama (JP)

(73) Assignee: Hitachi, Ltd.

(21) Appl. No.: 12/673,928

(22) PCT Filed: Jun. 23, 2009
(86) PCT No.: PCT/JP2009/061803

§ 371 Date: Feb. 17, 2010

(51) Int. Cl. G06F 21/20

(52) U.S. Cl. 726/3

(57) ABSTRACT

Provided is a computer system capable of ensuring sufficient security even when a computer resource of a server is dynamically allocated to a thin client. This computer system includes a plurality of computer resources for providing an arithmetic processing result to a thin client, a management device for deciding a prescribed computer resource from the plurality of computer resources according to a request from the thin client and allocating the decided computer resource to the thin client, and a coupling controller for restricting the thin client from coupling to a computer resource other than the decided prescribed computer resource.

### TECHNICAL FIELD

The present invention relates to a computer system, and specifically relates to a thin client system as the system architecture of minimizing the processing to be performed by the user's terminal and concentrating most of the processing on the server side.

### BACKGROUND ART

As this type of system, for instance, there is the type described in Japanese Unexamined Patent Application Publication No. 2007-299136. With this system, upon the thin client being coupled to a network, the server side is able to determine that the terminal is a thin client based on the address request message even before the thin client starts up the OS, and thereby realizes access control of the network according to the type of terminal.

In addition, Japanese Unexamined Patent Application Publication No. 2005-235159 describes a server client system in which a user couples a storage device equipped with a tamperproof device to an unspecified client, and remotely operates the server by using the authentication information and application in the storage device.

### PRIOR ART DOCUMENTS

### Patent Documents

Patent Document 1: Japanese Unexamined Patent Application Publication No. 2007-299136A

Patent Document 2: Japanese Unexamined Patent Application Publication No. 2005-235159A

### DISCLOSURE OF THE INVENTION

### Problems to be Solved by the Invention

A blade PC and a virtual PC are available as systems for mounting a thin client system. Conventionally, it was common practice for a server to statically allocate computer resources of a blade PC, a virtual PC or the like to the thin client. Nevertheless, with the foregoing method, the server was required to have computer resources of all users of the thin client.

Meanwhile, if the server is to dynamically allocate computer resources to the thin client, the system vendor only needs to prepare computer resources for the number of users of the thin client to be coupled to the server, and this is advantageous in terms of cost.

However, this method entails the following problems. With dynamic allocation, the destination computer resource to which the thin client is to be coupled is decided for the first time only when the thin client is coupled to the management server. Here, since it is not possible to know to which computer resource the thin client will be coupled, all of the computer resources as candidates to which the thin client will be coupled must all be allowed to be coupled to the thin client.

In the foregoing case, if the client falsifies the destination information, it will be possible to access a computer resource that is different from the designated computer resource, and system security will become vulnerable.

Specifically, if the thin client is dynamically allocated to a computer resource, there is a problem in that the thin client system is unable to ensure sufficient security.

Thus, an object of this invention is to provide a computer system capable of ensuring sufficient security even when a computer resource of a server is dynamically allocated to a thin client.

### Means for Solving the Problems

In order to achieve the foregoing object, the present invention couples the thin client only to an allocated resource based on the coupling control information at the time of dynamically allocating the thin client to a computer resource.

### Effect of the Invention

Accordingly, the present invention is able to provide a computer system capable of ensuring sufficient security even when a computer resource of a server is dynamically allocated to a thin client.

### BRIEF DESCRIPTION OF THE DRAWINGS

FIG. 1 is a hardware block diagram showing the first embodiment of a computer system according to the present invention.

FIG. 2 is an example of an information table related to communication information of a profile storage device.

FIG. 3 is an example of an information table related to user information.

FIG. 4 is an example of an information table related to communication information of a thin client.

FIG. 5 is an example of an information table related to communication information of a management server.

FIG. 6 is an example of an information table related to resource allocation information of a management server.

FIG. 7 is an example of an information table related to communication information of a network controller.

FIG. 8 is an example of an information table related to coupling control information of a network controller.

FIG. 9 is an example of an information table related to communication information of a blade PC.

FIG. 10 is a first timing chart showing the operation of a computer system according to the present invention.

FIG. 11 is a second timing chart thereof.

FIG. 12 is a third timing chart thereof.

FIG. 13 is a flowchart showing the operation of a user authentication program of a profile storage device.

FIG. 14 is a flowchart showing the operation of a remote control client program during user authentication.

FIG. 15 is a flowchart showing the operation upon the remote control client program of the thin client requesting the management server to allocate the blade PC to be used.

FIG. 16 is a flowchart showing the operation of device authentication processing between the thin client and the management server upon the thin client requesting the management server to allocate the blade PC.

FIG. 17 is a table indicating the combination between the devices to which device authentication processing will be performed.

FIG. 18 is a flowchart explaining the operation of the resource management program of the management server deciding the allocation of the computer resource to the authenticated terminal.

FIG. 19 is a flowchart explaining the operation of the coupling control program of the network coupling controller registering information of the blade PC that was allocated from the resource management program to the terminal in the coupling control information.

FIG. 20 is a flowchart showing the operation upon the remote control client program of the thin client requesting the allocation of the blade PC.

FIG. 21 is a flowchart explaining the operation of the remote control client program of the thin client to be performed to the blade PC.

FIG. 22 is a flowchart explaining the operation of the remote control manager program when the use of the blade PC is requested by the terminal.

FIG. 23 is a flowchart explaining the operation of the remote control manager program when the terminal performs an operation to the blade PC.

FIG. 24 is a flowchart explaining the operation of the remote control manager program upon sending an image from the blade PC to the terminal.

FIG. 25 is a flowchart explaining the operation of the remote control client program upon sending an image from the blade PC to the terminal.

FIG. 26 is a block diagram explaining the operation of the network coupling controller using the coupling control information table to monitor the coupling from the terminal to the blade PC.

FIG. 27 is a flowchart explaining the operation of a coupling control program of the network coupling controller.

FIG. 28 is a flowchart explaining the operation of a remote control client program when the use of the blade PC is to be ended.

FIG. 29 is a flowchart explaining the operation of the remote control manager program at such time.

FIG. 30 is a flowchart explaining the operation of the resource management program at such time.

FIG. 31 is a flowchart showing the operation of the coupling control program at such time.

FIG. 32 is a flowchart showing the operation of the remote control client program at such time.

FIG. 33 is a hardware block diagram of the second embodiment of the computer system according to the present invention.

FIG. 34 is a hardware block diagram of the third embodiment of the computer system according to the present invention.

### BEST MODE FOR CARRYING OUT THE INVENTION

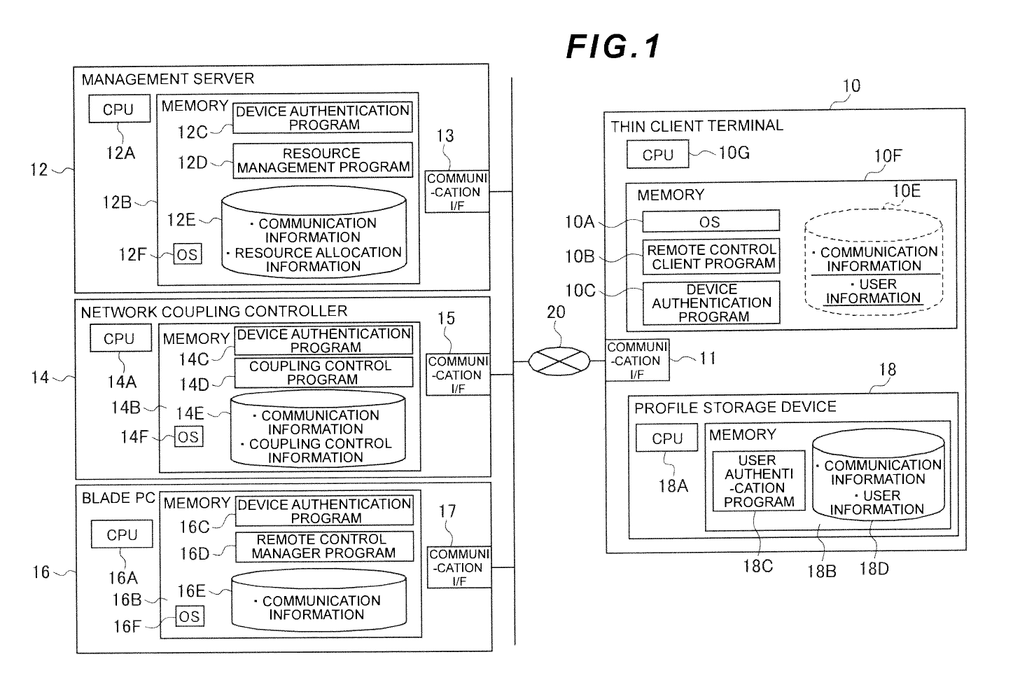

Embodiments of the present invention are now explained. FIG. 1 shows the hardware block diagram according to an embodiment of the computer system for realizing the thin client system of the present invention.

The term “thin client system” is a collective designation of systems which only allow a user's computer (client) to perform minimal functions, and manage resources such as application software and files on the server side. The computer as a terminal of the thin client system has limited functions such as a network coupling function and a display function.

The computer system comprises a thin client 10, a management server 12, a network coupling controller 14, and a blade PC (16) as the destination computer resource of the thin client. The thin client 10, the management server 12, the network coupling controller 14 and the blade PC (16) are mutually coupled via a network 20. Here, a plurality of blade PCs exist in the thin client system. The blade PC may also be mounted on a business server.

The thin client 10 comprises a central processing unit (CPU) 10G, a memory 10F, and a communication I/F (11) for coupling to the network. The thin client additionally includes an interface for coupling a profile storage device 18, and input devices such as a mouse and a keyboard.

The memory 10F stores an OS (10A), a remote control client program 10B, and a device authentication program 10C.

The profile storage device 18 is a device that stores information that is required for enabling user authentication or allowing the thin client 10 to perform communication/authentication with other devices such as the management server 12 and the blade PC (16). As an example, it is composed in a format of a USB memory as a device that is separate from the thin client 10.

The profile storage device 18 comprises a central processing unit 18A, and a memory 18B, and the memory 18B stores a program 18C for authenticating the thin client user, and communication information/user information 18D.

The profile storage device 18 comprises tamper proofness, and only allowed users are able to access the stored information.

When the profile storage device 18 is coupled to the thin client 10, the communication information and user information 18D of the profile storage device 18 is copied to the memory 10F of the thin client terminal (10E).

As a result of the power of the thin client 10 being turned off or the profile storage device 18 being removed from the terminal, under normal circumstances, a part or all of the communication information and user information 10E is deleted from the memory 10F.

Communication information (10E, 18D) is information that is used by the thin client 10 for the communication and authentication with the management server to 12 and a plurality of blade PCs (16), and contains coupling information to the respective device, information for the authentication with the respective devices, and information of the blade PC that was allocated to the thin client.

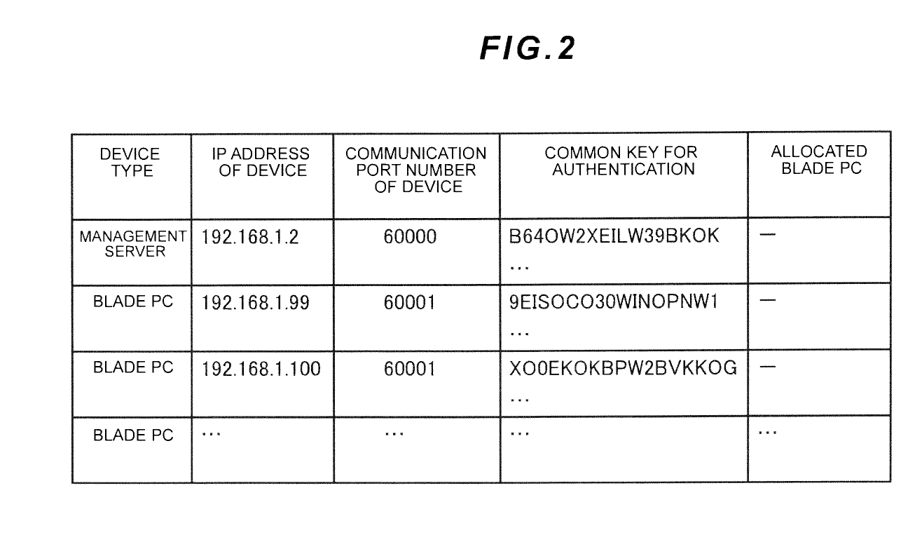

FIG. 2 shows an example of the information table containing communication information of the profile storage device 18. The communication information includes, as coupling information to the respective devices, “device type,” “IP address of device,” and “communication port number of device,” and additionally includes “common encryption key for authentication” as information for the authentication with the respective devices. The communication information additionally includes information concerning the existence of an “allocated blade PC” as information of the blade PC that was allocated to the thin client.

There are two device types; namely, a management server and a blade PC. Other items, such as the storage/update time of each piece of communication information, may be added to the communication information.

All values of the “allocated blade PC” of the communication information of the profile storage device 18 are “-”. This shows that the allocated blade PC has not yet been defined. The value of the “allocated blade PC” of the profile storage device 18 is “-” and not updated. The value of the “allocated blade PC” of the communication information 10E of the thin client terminal is updated and changed at the point in time that the communication information of the profile storage device 18 is copied to the thin client 10, and the blade PC is allocated to the thin client 10.

As the common key for authentication, separate keys may be used among the respective devices, or a key that is common among all devices may be used.

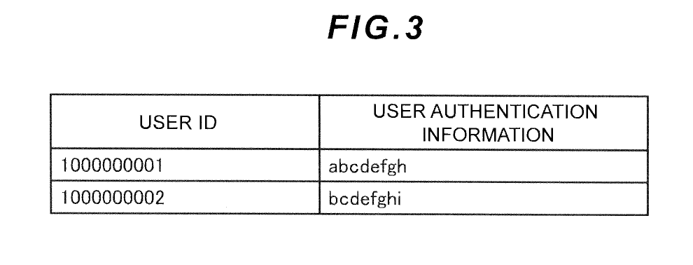

The user information 18D of the profile storage device 18 is information that is required for confirming that the user of the profile storage device is a legitimate user of the thin client. FIG. 3 shows an example of the user information table. FIG. 3 illustrates “user ID” and “user authentication information” (password) as the user information.

The user information is not limited to the foregoing items, and may also include other items such as the storage/update time of each piece of user information. The user information 18D of the profile storage device 18 may also include information of a plurality of users as shown in FIG. 3.

The user authentication program 18C of the profile storage device 18 is software for confirming that the user is a legitimate user by using the user information of FIG. 3.

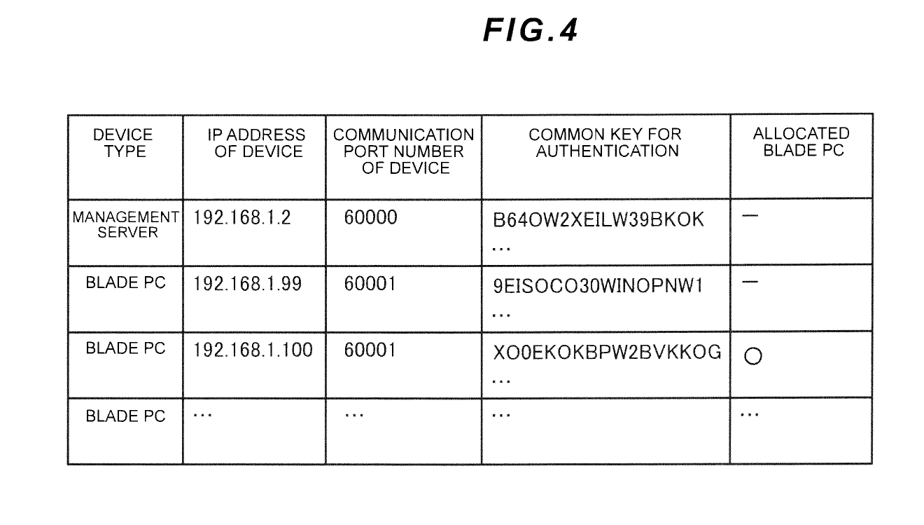

FIG. 4 shows an example of the information table containing the communication information 10E of the thin client 10. Since the communication information and user information 10E of the thin client 10 is copied from the profile storage device to the thin client after the profile storage device 18 is mounted on the thin client 10 and the user authentication is successful, and deleted from the memory 10F of the thin client when the user of the thin client ends the use of the blade PC, it is basically the same as the information that is stored in the profile storage device 18.

When the blade PC (16) is allocated to the thin client 10, the value of the “allocated blade PC” is changed from “-” to “∘” (shows that blade PC has been allocated). This change is not reflected in the communication information 18D of the profile storage device 18.

Although the memory 10F of the thin client terminal 10 registers the user ID among the user information 18D of the profile storage device 18 as user information, since user authentication information is highly secret information, it is not copied to the memory 10F of the thin client 10. As with the communication information, this information is similarly deleted after the user of the thin client ends the use of the blade PC.

The remote control client program 10B is a program that is loaded in the thin client of the operation source when operating a remote device (blade PC). The remote control client program 10B sends operation information to the blade PC (16) as the device of the operation source loaded with the remote control manager program 16D, and displays the screen image that is sent from the remote control manager program 16D of the operation source blade PC.

The device authentication program 100 of the thin client is software for implementing communication and authentication between the respective devices such as the management server 12 and the blade PC (16) by using the communication information.

The management server 12 is a computer for managing the blade PC (16) which, upon receiving a request from the thin client 10 for coupling to the blade PC (16), allocates a blade PC that is available to the thin client to the terminal on a case-by-case basis after confirming that the thin client is legitimate, and thereby enables the thin client to use the blade PC.

The management server 12 comprises a central processing unit 12A, a memory 12B, and a communication I/F (13) for coupling to a network. The memory 12B stores an OS (12F), a device authentication program 12C, a resource management program 12D, and communication information/resource allocation information 12E.

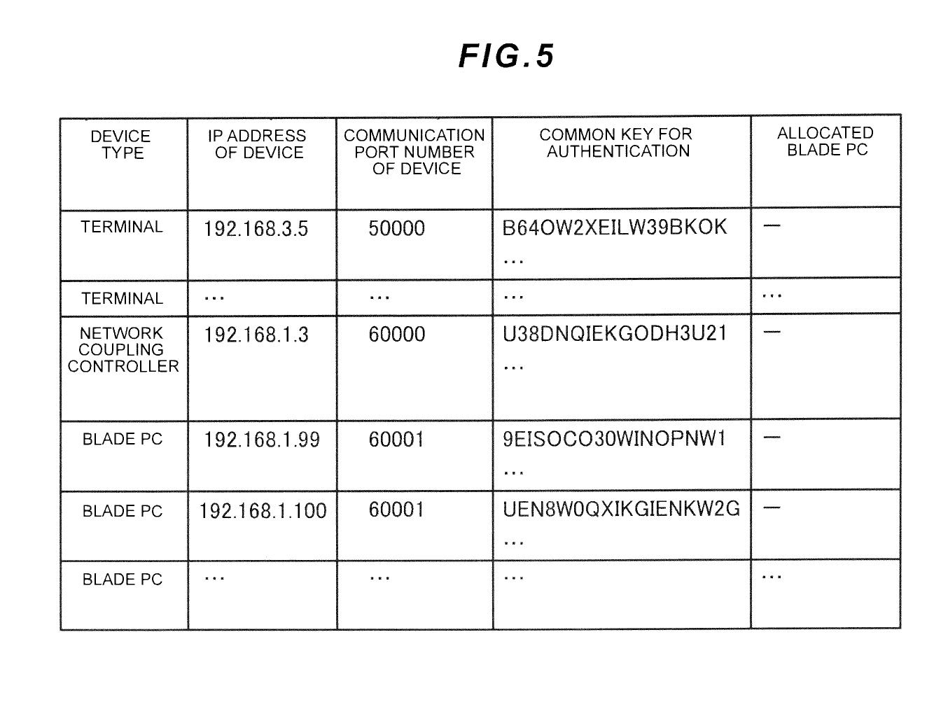

The communication information, as shown in FIG. 5, is information that is used by the management server 12 for implementing communication and authentication with the thin client 10, the network coupling controller 14, and the plurality of blade PCs (16), and includes a device type, coupling information (IP address of device, communication port number of device) to the respective devices, information (common key for authentication) for the authentication with the respective devices, and information of the blade PC that was allocated to the thin client.

When the resource management program 12D allocates the blade PC (16) to the thin client 10, it registers a flag showing such allocation in both the thin client and the blade PC. The IP address of the thin client 10 may be a fixed IP address that is stored in the thin client 10 or the profile storage device 18, or an IP address that is set by the DHCP server. In the case of the former, the administrator of the management server registers the IP address in the information table (FIG. 5). In the case of the latter, the device authentication program 12C or the resource management program 12D acquires the IP address from the remote control client program 10B or the device authentication program 100 of the thin client 10 when the thin client 10 accesses the management server 12.

The IP address of the network coupling controller 14 and the blade PC (16) is set in the information table by the administrator. The same applies to the communication port number of the respective devices. In addition, the management server 12 acquires the user ID in addition to the IP address from the thin client 10, and stores the user ID in a prescribed location of the memory 12B of the management server as the authentication information of the thin client 10.

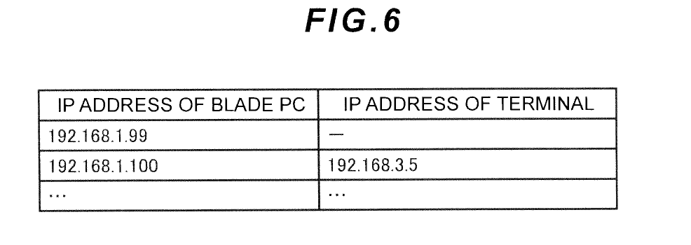

The resource allocation information 12E is information of a list concerning the allocation of the thin client to the computer resource (blade PC) that is managed by the management server 12. If the management server is to allocate (or cancel the allocation) of the blade PC to the thin client, it updates this information. FIG. 6 shows an example of the allocation information of the computer resource.

The allocation is defined based on the combination of the identifying information (IP address) of the computer resource (blade PC (16)) and the identifying information (IP address) of the thin client 10. The allocation may also be incorporated into the user ID.

If a blade PC is not allocated to the thin client, “-” is registered by the resource management program 12D of the management server 12 in the thin client IP address list of the information table (FIG. 6).

The device authentication program 12C of the management server 12 is software for implementing the communication and authentication between the respective devices such as the thin client 10, the blade PC (16), and the network coupling controller 14 by using the communication information 12E (FIG. 5). The management server 12 may also use the user ID upon authenticating the thin client.

The advantages of notifying the management server side of user information such as the user ID in addition to information that is unique to the device such as the IP address is now explained. If only information that is unique to the device such as the IP address is notified to the management server 12, under the following circumstances, the user of the thin client will not be able to make a recovery to a state in which the blade PC was previously used.

Specifically, the circumstances are a case where the user did not properly remove the profile storage device from the thin client, and a case where the user couples the profile storage device to a thin client located at a different base and attempts to continue business.

Under the foregoing circumstances, the current thin client is a separate device from the thin client to which the profile storage device was previously coupled by the user, and the IP address is also different. Here, with only device information such as the IP address, the management server is unable to search for the computer resource that was previously used since the IP address of the thin client is different. Nevertheless, if the user information is also registered on the management server side, the management server will be able to pinpoint the computer resource that was being used by the thin client to which the profile storage device was previously coupled since the user information is stored in the profile storage device.

The resource management program 12D is a program for managing the usage of the computer resource (blade PC), implements the allocation and cancelation of the computer resource to the thin client according to the use request from the thin client, and communicates information that is required for using the computer resource to the computer system.

The network coupling controller 14 monitors the communication on the network based on coupling control information of whether to allow or deny the communication between the devices existing on the network, and blocks the access between the devices that is not allowed in the coupling control information.

The network coupling controller 14 enables the coupling of the thin client 10 only to specific blade PCs which were allowed to be coupled to the thin client 10 by the management server 12. Examples of such a network coupling controller are a firewall and a router.

The network coupling controller comprises a central processing unit 14A, a memory 14B, and a communication I/F (15) for coupling to a network. The memory 14B stores an OS (14F), a device authentication program 14B, a coupling control program 14D, and communication information/coupling control information 14E.

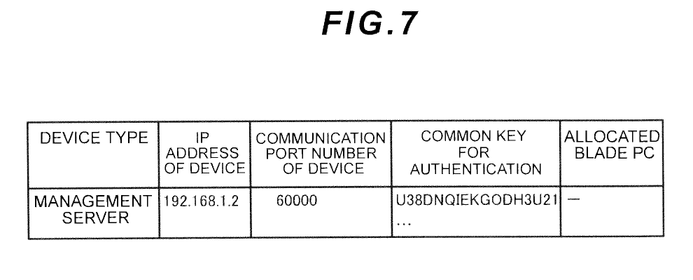

The communication information 14E, as shown in FIG. 7, is information that is used by the network coupling controller 14 for implementing communication and authentication with the management server 12, and contains a device type (management server), coupling information (IP address of device, communication port number of device) to the management server 12, information (common key for authentication) for performing authentication with the management server 12, and information concerning the allocated blade PC.

The coupling control information 14E is information that is used by the coupling control program of the network coupling controller upon controlling the communication between the respective devices (thin client, management server, computer resource (blade PC), network coupling controller).

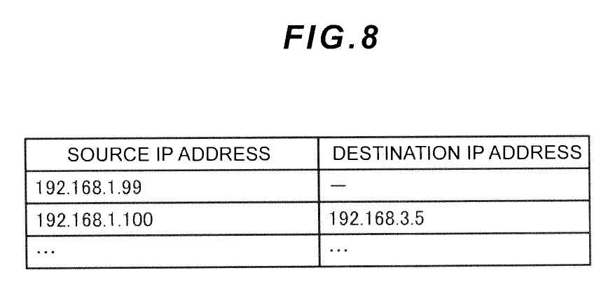

FIG. 8 shows an example of the coupling control information. The coupling control information contains the combination of mutually communicable devices and, for instance, this should be the “source IP address” and the “destination IP address.”

If the information is required for the network coupling controller 14 to control the coupling between the devices, then such information is not limited to the IP address and, for instance, it may also be a MAC address, computer name or the like.

The device authentication program 14C of the network coupling controller 14 is software for implementing communication and authentication with the management server 12 by using the communication information. The coupling control program 14D is software for controlling the coupling between the respective devices (thin client, management server, computer resource (blade PC)) based on the coupling control information 14E.

The blade PC (16) is a computer resource in which components (CPU, memory, hard disk and the like) configuring the personal computer are mounted on a substrate referred to as a blade, and the server is operated in a form where a plurality of blade PCs are integrated and mounted on a dedicated chassis. The blade PC performs software processing to the information input from the thin client 10, and returns to the processing result to the thin client terminal 10 by processing it into screen information.

The blade PC (16) comprises a central processing unit 16A, a memory 16B, and a communication I/F (17) for coupling with a network. The memory 16B stores a device authentication program 16C, a remote control manager program 16D, an OS 16F, and communication information 16E.

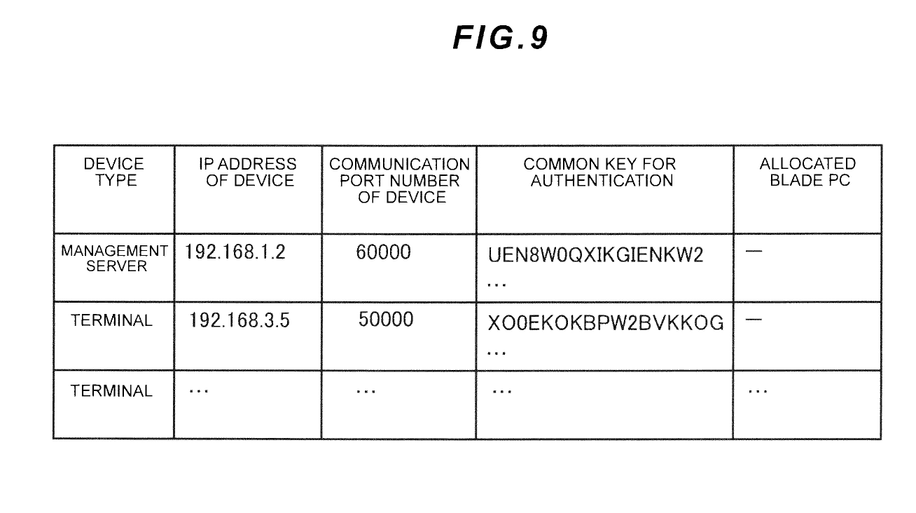

The communication information 16E of the blade PC (16) is information that is used by the blade PC in the communication and authentication with the management server 12 and the thin client 10 and contains, as shown in FIG. 9, a device type, coupling information (IP address of device, communication port number of device) to the respective devices, information (common key for authentication) for performing authentication with the respective devices, and information of the blade PC that was allocated to the thin client. The IP address of device, the communication port number of device, and the common encryption key for authentication are set by the administrator of the server in the information table of FIG. 5. When the blade PC is allocated to the thin client, the flag information to such effect of “∘” (allocated blade PC) is registered in the information table of FIG. 5. Incidentally, each of the plurality of blade PCs (16) contains communication information.

The device authentication program 16C of the blade PC (16) is software for implementing the communication and authentication with the management server 12 and the thin client 10 by using the communication information.

The remote control manager program 16D is software for executing software processing upon receiving a command from the thin client (terminal to which the remote control client program was loaded) of the operation source in a remote location.

The OS (16F) of the blade PC executes application software processing based on the input information of the thin client 10, executes read/write processing of file data, and sends the image information associated with such processing to a specific thin client as the operation source.

The computer system comprises a plurality of blade PCs, and one blade PC is allocated to one thin client. The computer system may comprise a plurality of thin clients.

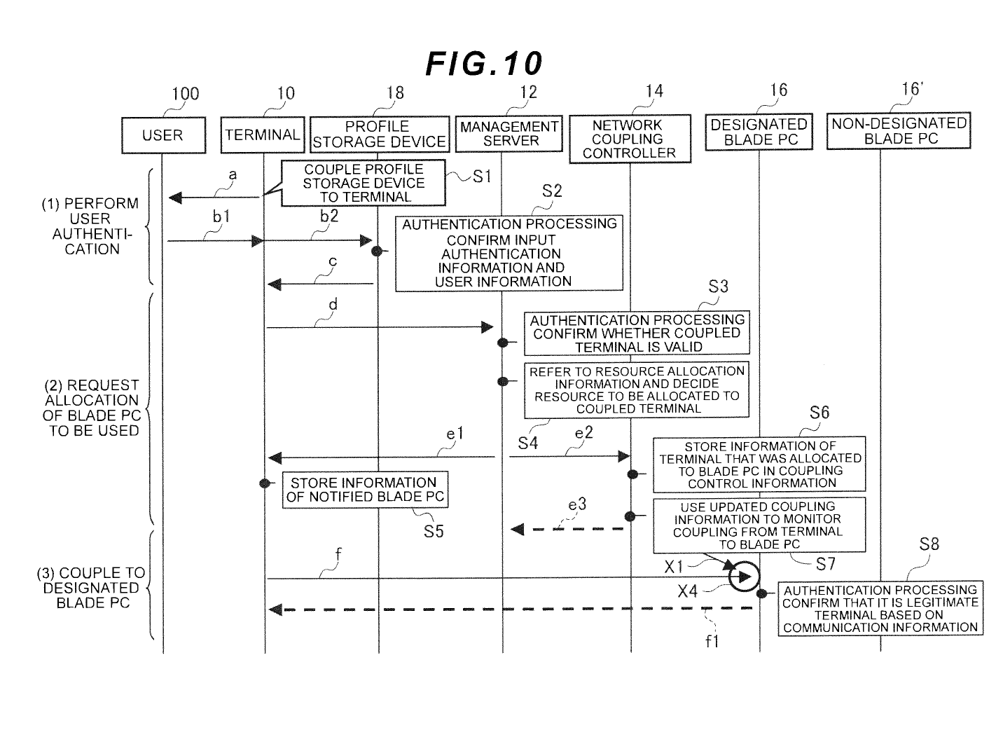

The mutual related operation of the user of the thin client, the thin client 10, the profile storage device 18, the management server 12, the network coupling controller 14, the blade PC (16) that was designated by the management server to be allocated to the thin client, and the non-designated blade PC (16′) is now explained based on the timing chart shown in FIG. 10 to FIG. 12. This timing chart is sequential from FIG. 10 to FIG. 12. Moreover, in the ensuing explanation, the operation of the respective programs is also explained in detail by referring to the flowcharts shown in the other diagrams.

The operation of the computer system is configured from respective stages of (1) implementation of user authentication, (2) allocation request of the blade PC to be used to the thin client, (3) coupling from the thin client to the designated blade PC by the management server, (4a) implementation of operation from the thin client to the blade PC, (4b) sending of an image from the blade PC to the thin client, (5) end of use of the blade PC, and (3′) coupling of the thin client to the non-designated blade PC.

The stage of implementation of user authentication ((1) of FIG. 10) is foremost explained. The user 100 of the thin client couples the profile storage device 18 to the thin client 10 (S1). Then, the remote control client program 10B of the thin client 10 displays the input screen of the user information (user ID, password) to the user 100 of the thin client (a of FIG. 10).

Subsequently, when the user inputs the authentication information to the remote control client program 10B (b1), the remote control client program 10B provides the input information to the user authentication program 18C of the profile storage device 18 (b2).

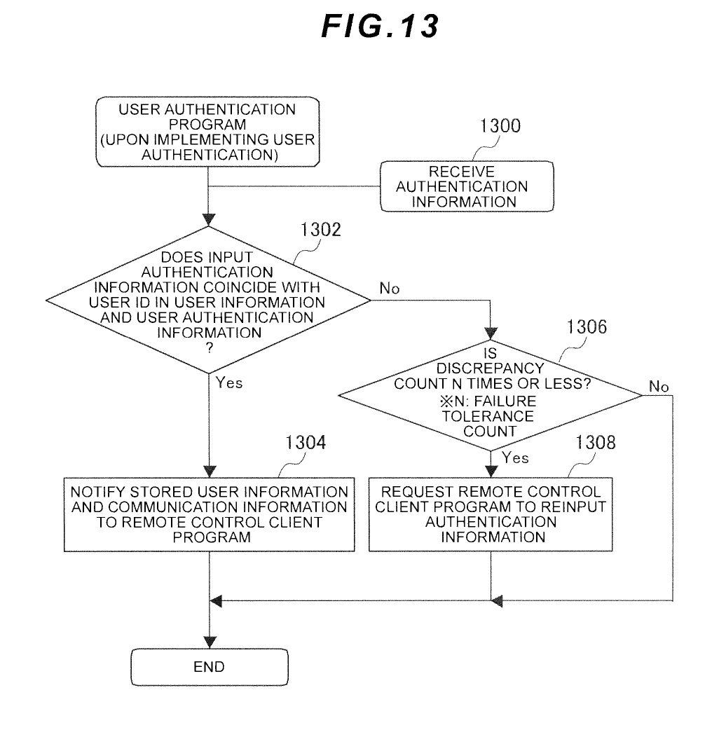

FIG. 13 is a flowchart showing the operation of the user authentication program 18C of the profile storage device. Although the programs are explained as the execution entity of the respective processes in the ensuing explanation of the flowcharts, this is for the sake of simplifying the explanation, and the respective processes are actually executed by the central processing unit that executes the programs.

When the user authentication program 18C receives personal authentication information (the user ID and secret information such as the password) of the user from the thin client 10 (1300), it determines whether the notified authentication information and the user information stored in the memory 18B as the user information 18D of the profile storage device coincide (1302/S2 of FIG. 10).

If the user authentication program 18C affirms the foregoing determination, it transfers the communication information and the user ID among the user information stored in the profile storage device 18 to the remote control client program 10B of the thin client 10 (1304/c of FIG. 10).

Here, the remote control client program 10B of the thin client stores the communication information/user information (10E) in the memory 10F.

Meanwhile, if the user authentication program 18C denies the foregoing determination (1302), it determines whether the discrepancy determination count is a tolerable count (N) or less (1306). If the user authentication program 18C affirms the foregoing determination, it requests the remote control client program 10C to re-execute the input processing of the authentication information.

Meanwhile, if the user authentication program 18C denies the foregoing determination (1306), it notifies the authentication failure to the remote control client program 10C and then ends the flowchart. The remote control client program 10B that received the foregoing notice presents the screen information of the authentication failure to the user 100 of the thin client.

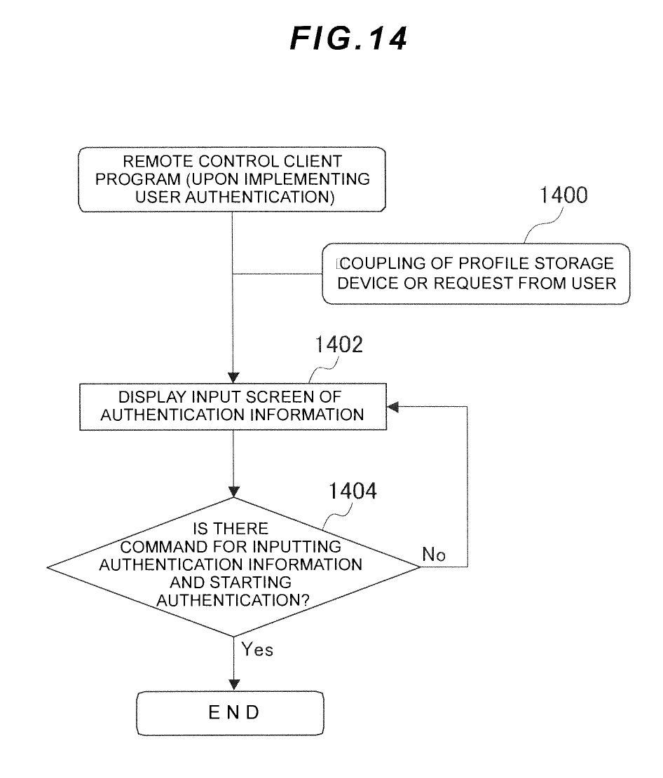

FIG. 14 is a flowchart showing the operation of the remote control client program 10B upon user authentication. When the remote control client program 10B receives a coupling request of the profile storage device 18 to the thin client 10 (S1 of FIG. 10), or a display request of the input screen of authentication information from the user (1400), it displays the input screen of the authentication information (user ID and authentication information) to the user of the thin client (1402/a of FIG. 10).

When the remote control client program 10B determines that it has received the input of authentication information and a command for starting authentication, each from the user to the thin client (1404/b1 of FIG. 10), it notifies the authentication information to the user authentication program 18C of the profile storage device (b2 of FIG. 10), and then ends the flowchart.

The allocation of the blade PC to be used to the thin client is now explained ((2) of FIG. 10). The remote control client program 10B of the thin client refers to the IP address and communication port number of the management server 12 of the communication information (FIG. 4), and foremost accesses the management server 12. Here, the remote control client program 10B of the thin client sends a request to the resource management program 12D of the management server to issue a command pertaining to the designation of the blade PC to be accessed (d of FIG. 10).

Before the resource management program 12D of the management server executes this request, the device authentication program 12C of the management server performs authentication processing of the thin client with the device authentication program 10C of the thin client (S3 of FIG. 10). Subsequently, the resource management program 12D of the management server refers to the resource allocation information 12E, and decides the computer resource (blade PC) to be allocated to the thin client that was coupled to the management server (S4 of FIG. 10).

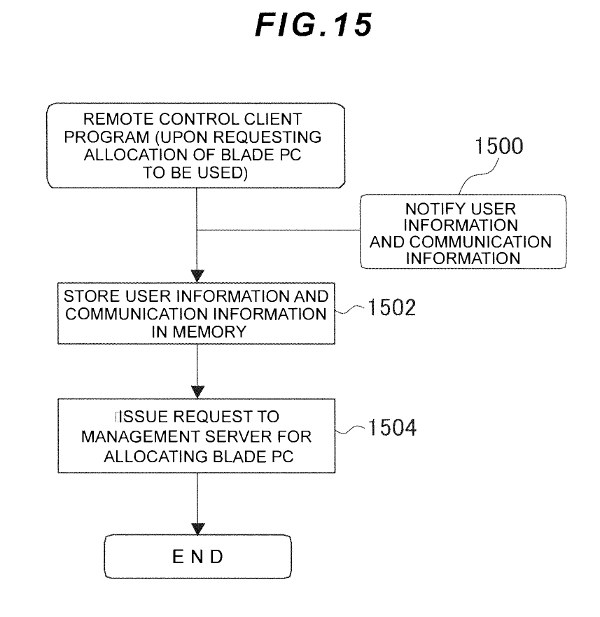

FIG. 15 is a flowchart showing the operation upon the remote control client program 10B of the thin client requesting the management server 12 to allocate the blade PC (16).

When the remote control client program 10B receives a notice of the user information and communication information from the profile storage device 18 (1500) and stores this in the memory 10F (1502), it sends a request to the resource management program 12D of the management server 12 to allocate the blade PC (1504).

The device authentication processing to between the respective devices is now explained mainly regarding the device authentication processing to be performed between the thin client 10 and the management server 12.

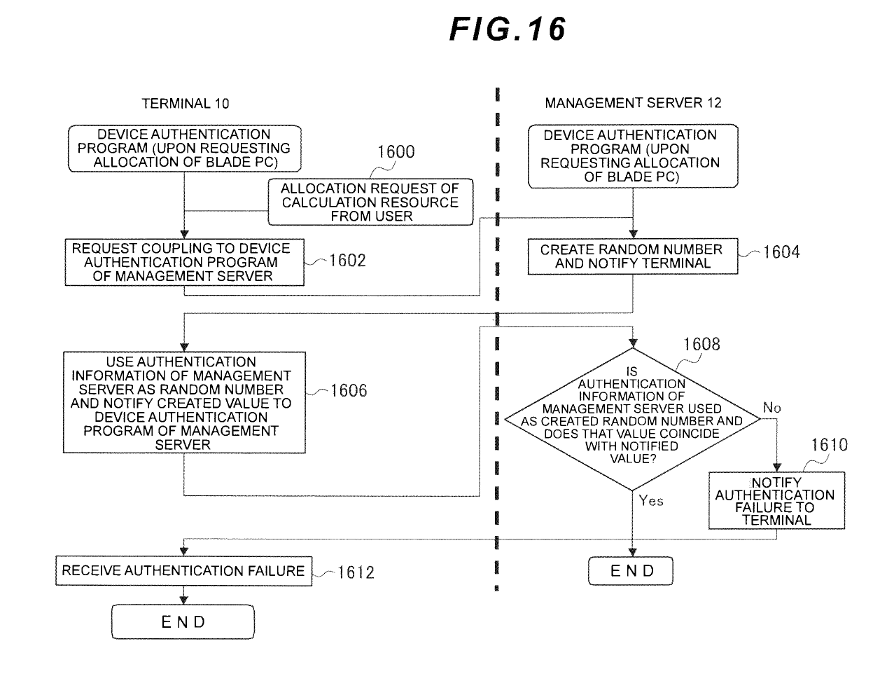

FIG. 16 is a flowchart showing the operation of the device authentication processing between the thin client 10 and the management server 12 upon requesting the allocation of the blade PC (16) from the thin client 10 to the management server 12. Although various methods can be employed as the authentication method between the thin client and the management server, the challenge and response method is explained below.

When the device authentication program 10C of the thin client 10 receives an input requesting the allocation of the computer resource from the user (1600), the device authentication program 10C requests the coupling to the device authentication program 12C of the management server 12 (1602).

The device authentication program 12C of the management server registers identifying information such as the IP address and port number of the thin client that requested the coupling in the communication information table (FIG. 5).

The device authentication program 12C of the management server that received the request from the thin client creates a random number, and sends this to the device authentication program 10C of the thin client (1604).

The device authentication program 10C of the thin client notifies the device authentication program 12C of the management server 12 of the value that was created by applying authentication information (common key for authentication) of the management server of the communication information table (FIG. 4) that it stores to the random number (1606).

The management server 12 that received the foregoing notice compares the value that was obtained by applying its own authentication information (common key for authentication), and the value that was notified from the thin client (1608). If the thin client is legitimate, since the random number is encrypted using the same common key, the values will be the same. Thus, the device authentication program 12C of the management server notifies a request to the resource management program 12D for allocating the computer resource 16 to the thin client 10, and then ends the flowchart.

Upon sending information of the allocated blade PC from the management server 12 to the thin client 10, since the authentication between the thin client and the management server is complete, there is no need to perform authentication processing again. Incidentally, the authenticated devices may be subject to measures such as encryption in order to protect the subject matter of communication.

Meanwhile, if the thin client is not legitimate, the device authentication program 12C notifies the authentication failure to the thin client 10 that accessed the management server 12 (1610). The device authentication program 10C of the thin client receives the foregoing authentication failure notice (1612), notifies this information to the user via the display device of the thin client, and then ends the flowchart.

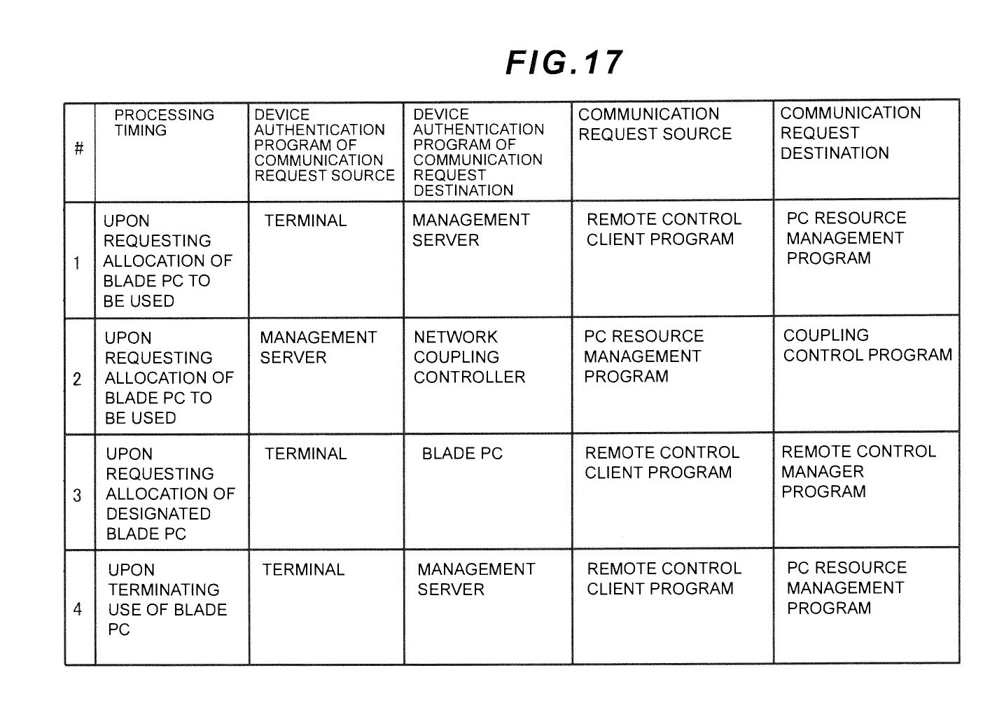

Other communications (between management server and network coupling controller, terminal and blade PC) than the communication between the thin client and the management server, similar authentication is implemented. The processing routine in the foregoing case is similar to the flowchart of FIG. 16, and the communication request source, the communication request destination, the communication request source device authentication program, and the communication request destination device authentication program in the flowchart of FIG. 16 should be read with conversion according to FIG. 17.

As described above, #1 of FIG. 17 shows the detailed affiliation of the communication request source program, the communication request destination program, and the device authentication programs of the communication request source and the communication request destination upon authentication when the communication is to be implemented, upon implementation of communication from the thin client to the management server, #2 shows a case upon the management server being coupled to the network coupling controller, #3 shows a case of the thin client being coupled to the designated blade PC by the management server, and #4 shows a case upon the thin client being coupled to the management server when the thin client ends the use of the blade PC.

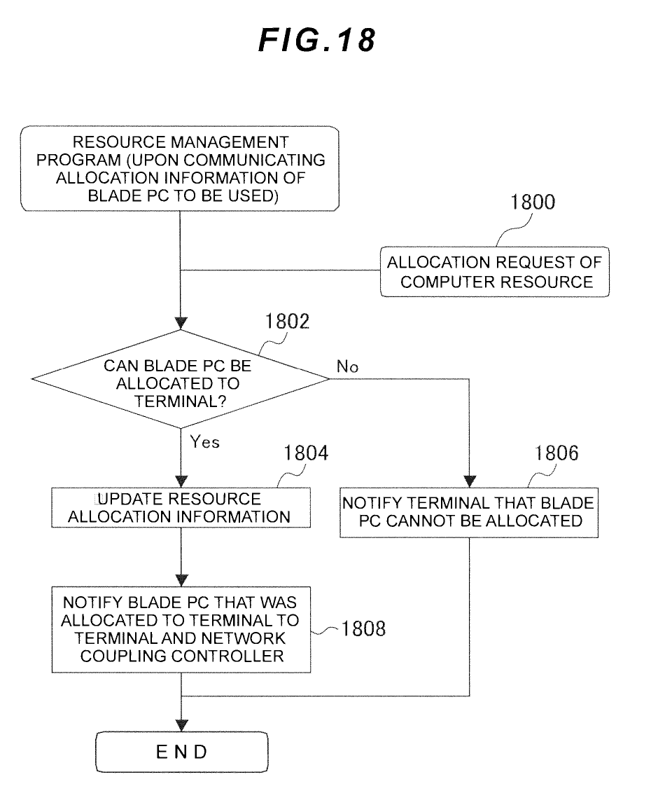

When the device authentication program 12C of the management server completes the authentication of the thin client, the resource management program 12D decides the allocation of the computer resource to the authenticated thin client. This operation is now explained with reference to FIG. 18.

When the resource management program 12D receives an allocation request of a computer resource from the device authentication program 12C (1800), it determines whether it is possible to allocate a computer resource to the thin client that issued the request (1802).

The resource management program 12D refers to the communication information table of the FIG. 5 and selects a prescribed blade PC among the plurality of unallocated blade PCs that have not yet been allocated to the thin client arbitrarily or according to a prescribed priority, and updates and sets the information pertaining to the selected blade PC in the information table of FIG. 5 and FIG. 6 (1804).

Meanwhile, if the resource management program 12D refers to the communication information table of FIG. 5 and determines that there is no blade PC that can be allocated to the thin client (1802), it notifies the remote control client program 10B of the thin client to the effect that the blade PC cannot be allocated (1806), and then ends the flowchart.

When the resource management program 12D decides the blade PC to be allocated to the thin client, it notifies the identifying information (IP address, port number) of the blade PC to the thin client 10 and the network coupling controller 14 (1808/e1, e2 of FIG. 10).

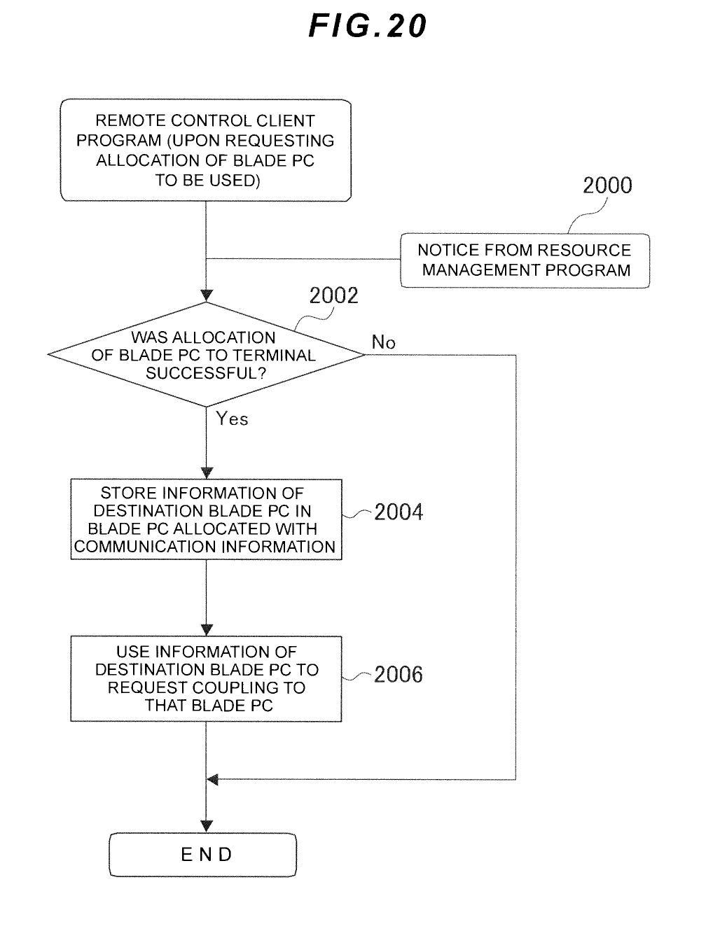

As shown in FIG. 20, when the remote control client program 10B of the thin client receives the foregoing notice (2000), it determines whether the allocation of the blade PC was successful (2002), refers to the information table of FIG. 4 based on the notified information, and registers the allocation information in the blade PC that corresponds to such information (2004/S5 of FIG. 10).

As explained in (3) of FIG. 10, the remote control client program 10B uses the information of the destination blade PC (16) to request the coupling to that blade PC (2006/f of FIG. 10).

The device authentication program 16C of the blade PC that received the foregoing request performs authentication processing to the device authentication program 10C of the thin client based on the communication information shown in FIG. 9, confirms that the thin client to be coupled is a legitimate thin client, and thereafter allows the remote control manager program 16D to communicate with the remote control client program 10B (S8 of FIG. 10). The remote control manager program 16D sends a notice to the remote control client program 10B of the coupling target terminal to the effect that the communication has started (f1 of FIG. 10).

Incidentally, if the remote control client program 10B determines that a target blade PC does not exist in the information table (FIG. 4), it may also register the unique information of such blade PC in the information table.

In the determination (2002), if the remote control client program 10B determines that the notice (2000) from the resource management program indicates allocation failure of the blade PC (16), it ends the flowchart without attempting to couple to the blade PC.

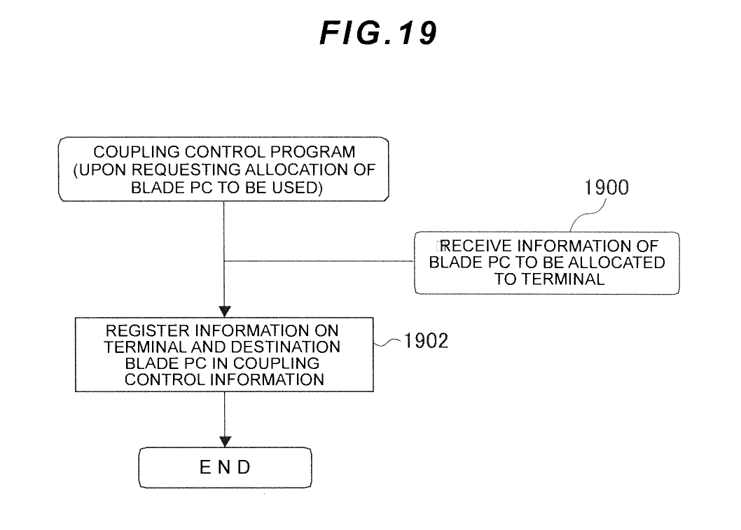

FIG. 19 is a flowchart explaining the operation of the coupling control program 14D of the network coupling controller 14 registering information of the blade PC that was allocated to the thin client in the coupling control information from the resource management program 12D.

When the coupling control program 14D receives information of the blade PC to be allocated to the thin client from the resource management program 12D of the management server (1900), it registers the information (source IP address) of the thin client and the information (destination IP address) of the blade PC in the coupling control information (FIG. 8) (1902/S6 of FIG. 10).

The coupling control program 14D uses the updated coupling information and resumes monitoring the coupling from the thin client 10 to the blade PC 16 (S7 of FIG. 10). Subsequently, the coupling control program 14D sends a completion notice to the management server 12 (e3 of FIG. 10).

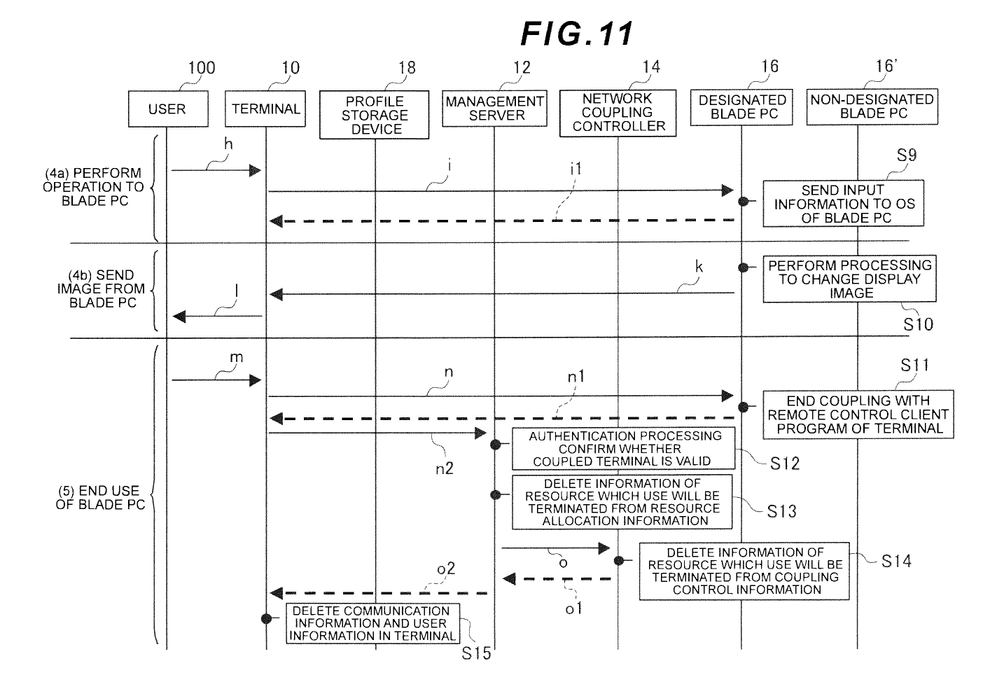

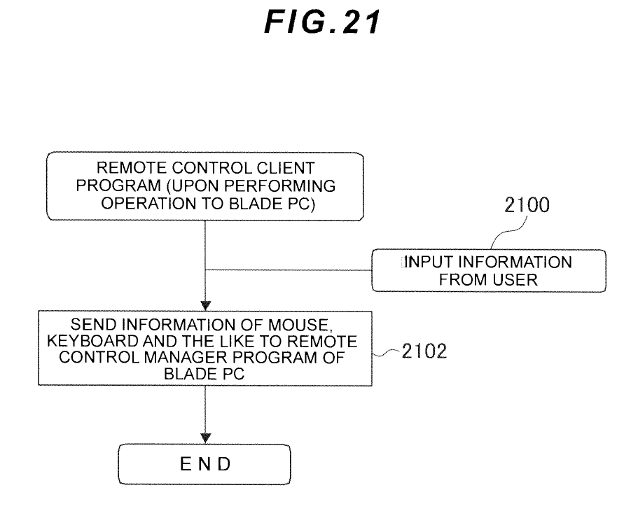

Subsequently, when the “coupling to blade PC” of FIG. 10 (3) is concluded, during the implementation of operation (4a) to the blade PC of FIG. 11, as shown in FIG. 21, the remote control client program 10B of the thin client provide an input screen to the user, and, upon receiving input information of the user to the blade PC (2100/h of FIG. 11), it sends the user input information to the remote control manager program 16D of the blade PC (2102/i of FIG. 11).

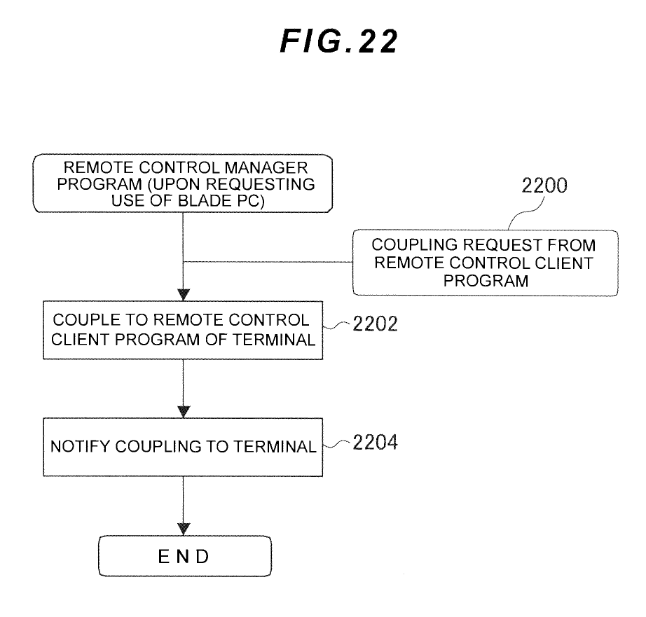

FIG. 22 shows the operation of the remote control manager program 16D in the foregoing case. Upon receiving a coupling request from the remote control client program 10B of the thin client (2200/f of FIG. 10), the remote control manager program 16D couples to the remote control client program 10B of the thin client (2202), and, after establishing this coupling, notifies the coupling success to the remote control client program of the thin client (2204/f1 of FIG. 10).

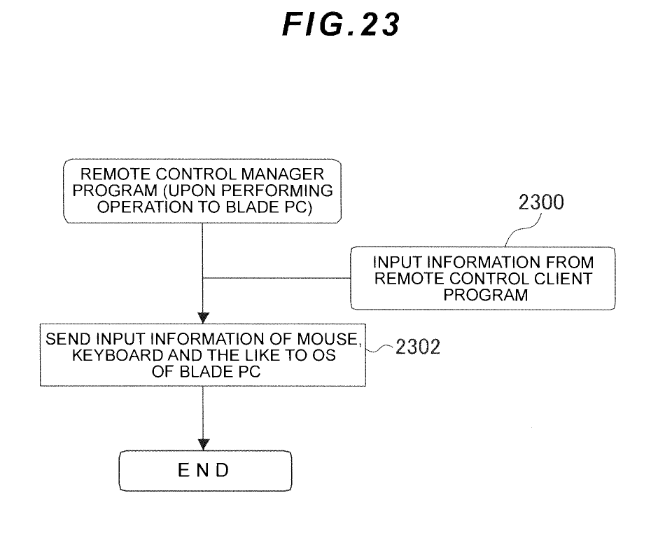

Subsequently, at the stage of 4a of FIG. 11, when the remote control manager program 16D receives information of the mouse/keyboard or the like from the remote control client program 10B as shown in FIG. 23 (2300), it sends this to the OS (16F) of the blade PC (2302/S9 of FIG. 11). The OS notifies the reception of input information to the remote control client program 10B of the thin client (i1 of FIG. 11).

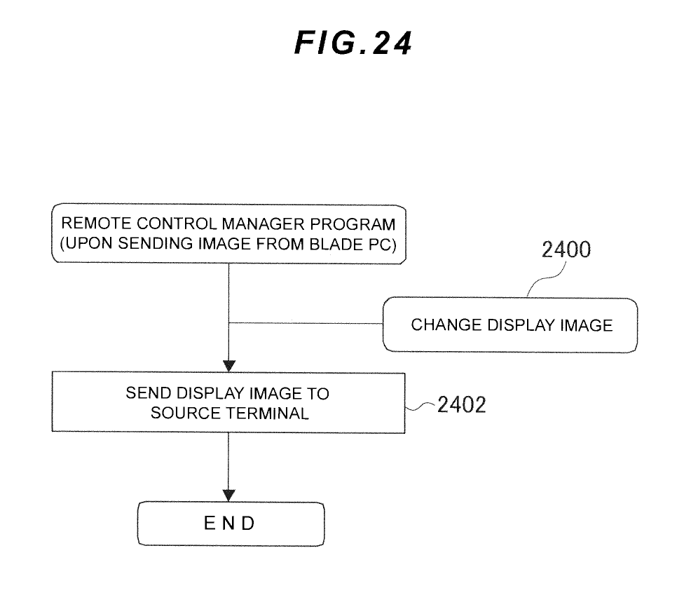

When the OS (16F) proceeds to the stage of 4b of FIG. 11 and performs business processing such as executing an application program based on the input information, as shown in FIG. 24, the remote control manager program 16D receives change information of display image from the OS (2400/S10 of FIG. 11), and sends the display image information to the remote control client program 10B of the source thin client (2402).

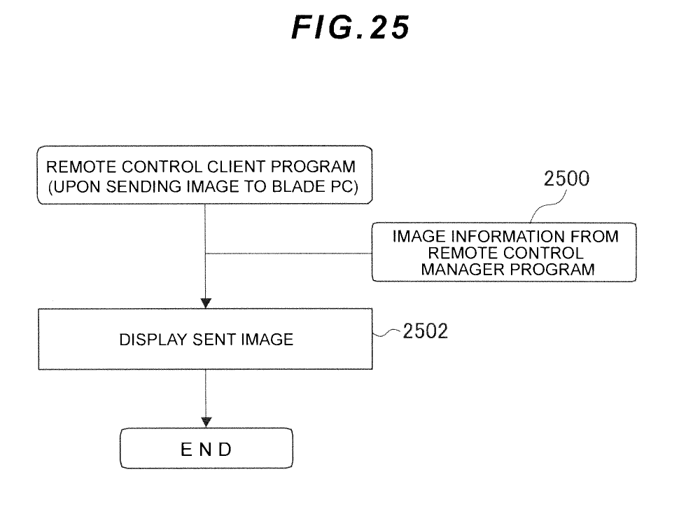

Then, as shown in FIG. 25, when the remote control client program 10B receives the image information from the remote control manager program 16D (2500/k of FIG. 11), it notifies this to the user of the thin client (2502/l of FIG. 11).

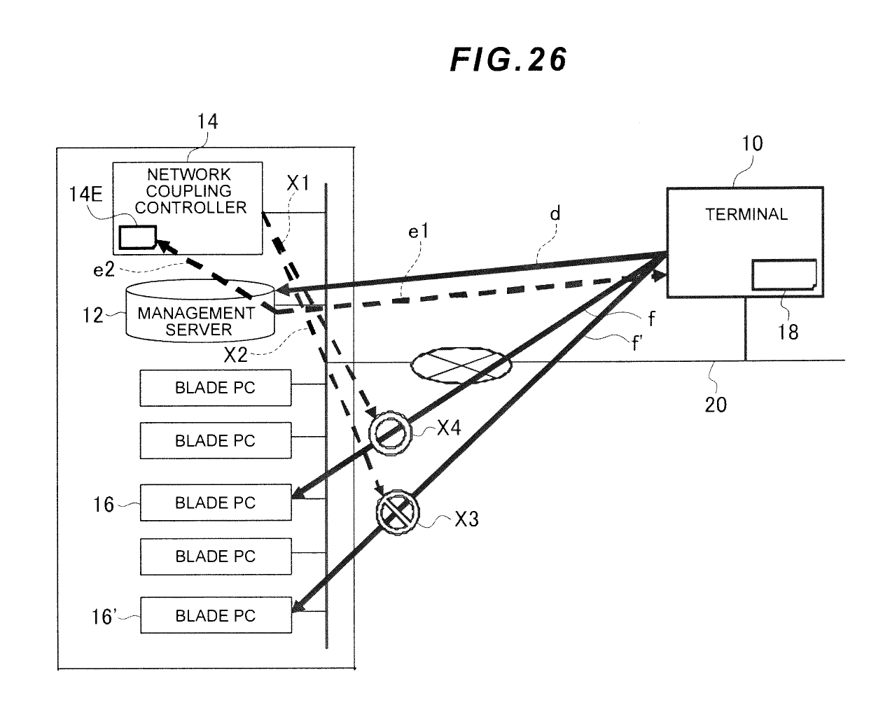

The network coupling controller 14 that received the notice of the blade PC to be allocated to the thin client 10 from the management server 12 monitors the coupling from the thin client 10 to the blade PC (16) by using the updated coupling control information table. FIG. 26 is a block diagram explaining the monitoring operation. The reference numerals shown in FIG. 26 show the same operation as FIG. 10 to FIG. 12. “X1” shows the monitoring operation of the coupling control program 14D of the network coupling controller 14 to the combination of the thin client 10 and the blade PC (16) to which coupling was allowed, “X2” shows the monitoring program of the same program to the combination of the thin client 10 and the blade PC (016′) to which coupling was not allowed. “f” shows the access from the thin client 10 to the blade PC (16) to which coupling of the terminal 10 was allowed, and “f” shows the access to the blade PC (16′) to which coupling of the thin client 10 was not allowed.

As described above, the thin client 10 initially couples to the management server 12 and requests the allocation of the blade PC (16). After the authentication of the thin client is successful, the management server 12 allocates the blade PC (16) to the thin client 10 to which coupling was allowed.

The management server 12 thereafter sends information of the blade PC allowing the coupling to the thin client 10 and the network coupling controller 14. Here, the network coupling controller 14 stores the foregoing information in the coupling control information 14E, and the thin client 10 stores the foregoing information in the communication information 10F.

The thin client 10 is coupled to the blade PC based on information of that blade PC (16) to which coupling was allowed. Here, the network coupling controller 14 allows the thin client 10 to access only the blade PC (16) of the coupling designated destination based on the coupling control information 14E. Consequently, since the coupling scope of the thin client can be narrowed down to the blade PCs of the coupling designated destination, the security risk of the thin client system can be reduced even upon dynamically allocating the blade PC to the thin client.

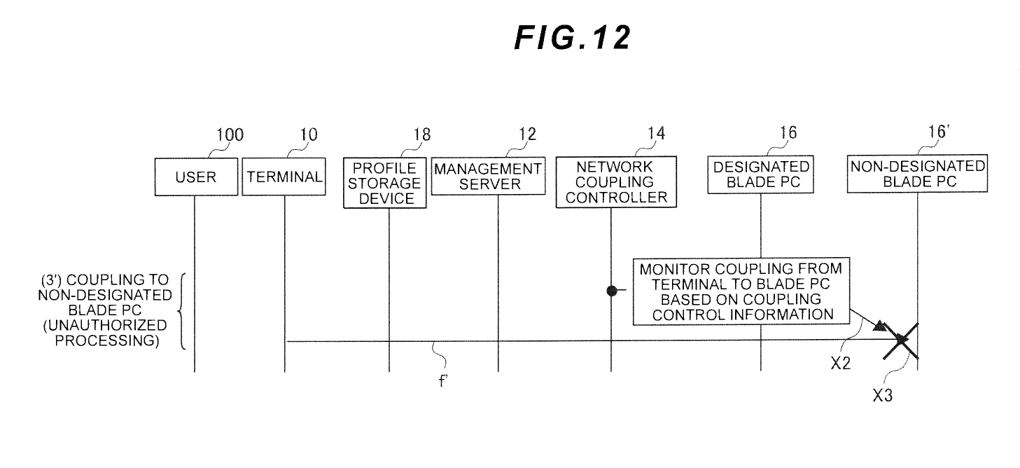

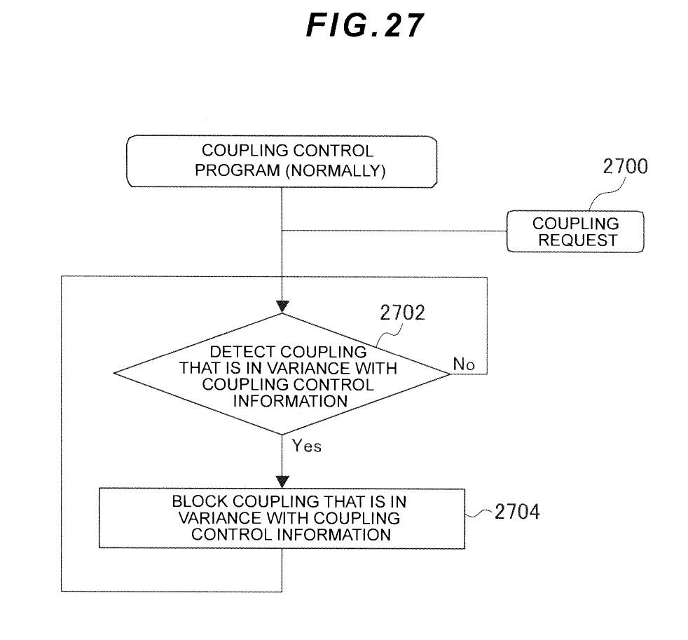

The network coupling controller 14 is used for constantly monitoring the coupling of the thin client 10 and the blade PC (16) of the computer system shown in FIG. 1, and, as shown in the flowchart of FIG. 27, the coupling control program 14D refers to the coupling control information (FIG. 8) at the timing of receiving the coupling to blade PC request from the thin client 10 (2700) or the like, and detects whether the coupling request or the coupling itself coincides with or is in variance with the coupling control information (2702). Upon detecting a request or coupling that is in variance with the coupling control information (f′, x2 of FIG. 12 and FIG. 26), it attempts to block the coupling between the thin client and the blade PC that is in variance with the coupling control information (2704/X3 of FIG. 12 and FIG. 26). If the coupling control program 14D does not detect any request or coupling that is in variance with the coupling control information in the determination (2702), as shown in X4 of FIG. 11 and FIG. 26, the coupling between the thin client 10 and a specific blade PC (16) is started or maintained.

With a system that dynamically allocates a computer resource to a thin client, if a program that performs similar operations as a remote control client program is loaded in a terminal (a generally used PC that is referred to as a rich client in relation to a thin client) that is able to freely operation the storage area (HDD or memory) in substitute for the thin client, upon coupling to the blade PC, it will be possible to access a blade PC that is different from the designated blade PC merely by directly rewriting the information of the source terminal. However, since the coupling control program 14D of the network coupling controller monitors/controls the coupling of the terminal and the blade PC based on the coupling information 14E, it is possible to prevent this kind of problem from occurring.

The operation ((5) of FIG. 11) to be performed when the user of the thin client is to end the use of the blade PC is now explained with reference to the flowcharts showing the operation of programs of the respective devices.

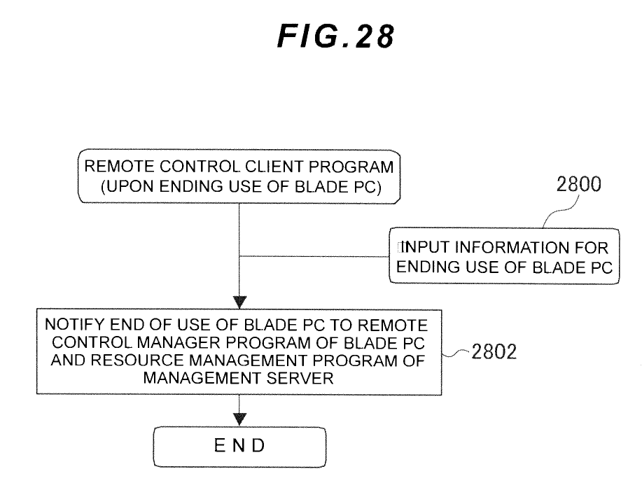

As shown in FIG. 28, when the user performs operations for ending the use of the blade PC to the remote control client program 10B of the thin client (m of FIG. 11), the remote control client program receives such input information (2800), and notifies a request for ending the use of the blade PC to the remote control manager program 16D of the destination blade PC and the resource management program 12D of the management server (2802/n, n2 of FIG. 11).

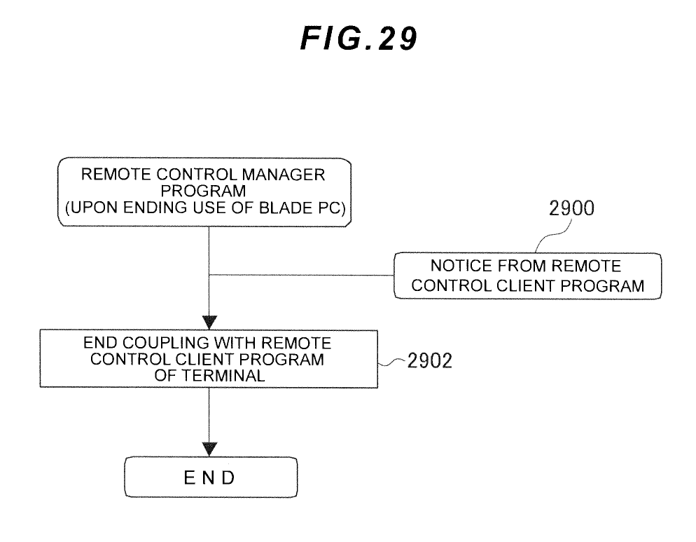

As shown in FIG. 29, when the remote control manager program 16D of the blade PC receives a request for ending the use of the blade PC from the remote control client program 10B (2900), it ends the coupling with the remote control client program of the notice source thin client (S11 of FIG. 11), and notifies the remote control client program of the notice source thin client to such effect (2902/n1 of FIG. 11). The remote control manager program 16D deletes the allocation information of the blade PC to the notice source thin client from the communication information (FIG. 9).

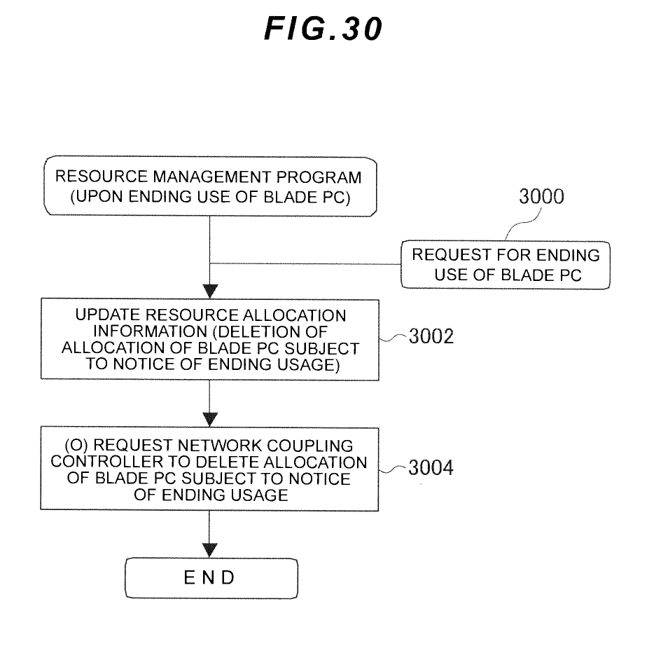

The remote control client program 10B of the thin client sends a notice of ending the use of the blade PC to the resource management program 12D of the management server. When the resource management program receives a request for ending the use of the blade PC from the thin client as shown in FIG. 30 (3000), it performs authentication processing to the thin client (S12), and thereafter performs update processing of deleting the allocation information to the blade PC subject to the notice of ending the usage from the resource allocation information 12E (3002/S13 of FIG. 11).

The resource management program 12D sends a notice for ending the use of the blade PC to the coupling control program 14D of the network coupling controller (o of FIG. 11), and a request for deleting the allocation information of the blade PC subject to the request for ending the use from the coupling control information (FIG. 8). The management server thereafter sends a confirmation notice to the thin client regarding the end of the usage of the blade PC (o2 of FIG. 11).

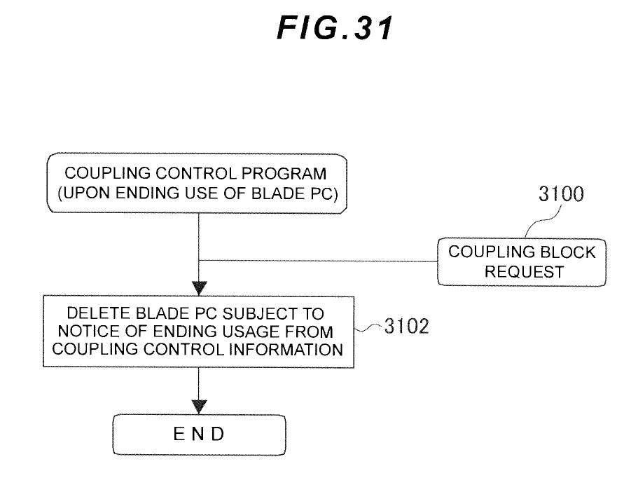

When the coupling control program 14D of the network coupling controller receives a coupling block request designating the (IP address) of the thin client and the destination blade PC from the resource management program 12D of the management server as shown in FIG. 31 (3100), it deletes the allocation information of the blade PC subject to the notice for ending the use from the coupling control information (S14 of FIG. 11), and notifies the result thereof to the resource management program (3102/o1 of FIG. 11).

At this point in time, the blade PC subject to a request from the thin client for ending the use thereof will end its coupling with the thin client. However, even assuming that the coupling is continued, the coupling control program of the network coupling controller will determine that the coupling of the blade PC and the thin client is unauthorized, and forcibly block the coupling.

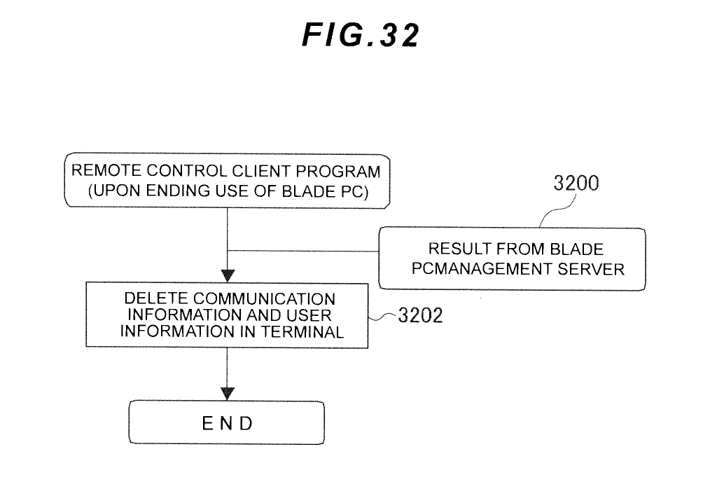

When the remote control client program 10B of the thin client receives the result of the cancelation of the allocation of the blade PC from the blade PC and the management server as shown in FIG. 32 (3200), it deletes the communication information and user information 10E from the memory 10F (3202/S15 of FIG. 11).

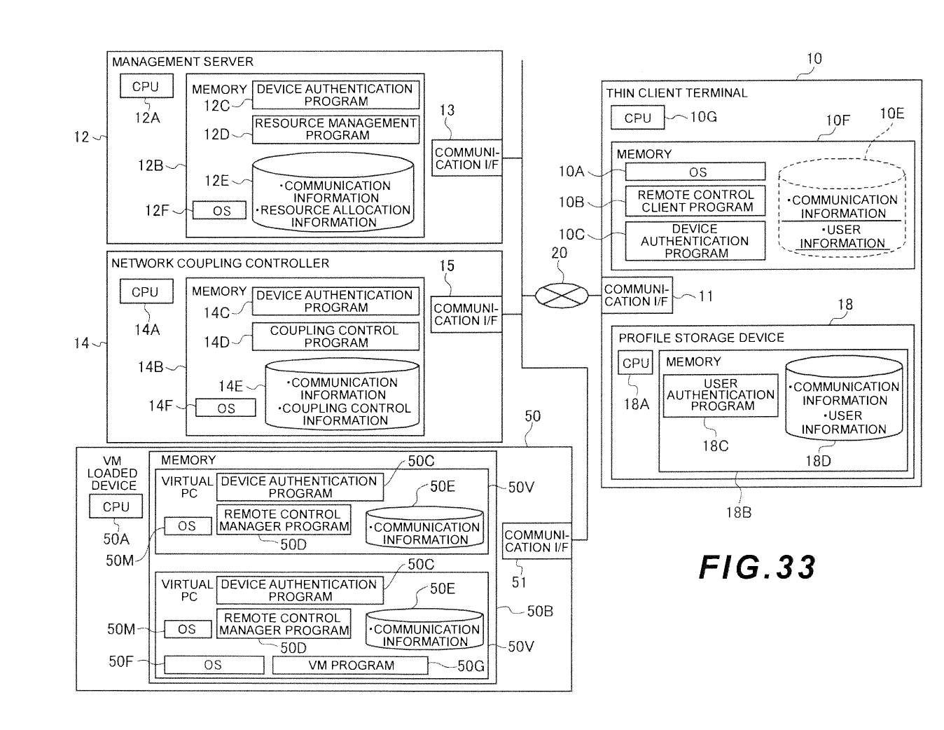

The second embodiment of the computer system according to the present invention is now explained. FIG. 33 is a hardware block diagram thereof, and differs from the mode of FIG. 1 in that a virtual PC as a VM (Virtual Machine) is used in substitute for the blade PC as the computer resource.

In FIG. 33, a server 50 as a VM mounted device comprises a central processing unit 50A, a memory 50B, and a communication I/F (51), and the memory 50B is loaded with a plurality of virtual PCs (50V). Each virtual PC stores an OS (50M), a device authentication program 50C, a remote control manager program 50D, and communication information 50E. Reference numeral 50F shows the server OS. Reference numeral 50G shows the (VM) Virtual Machine program. As a result of the VM program being loaded in the server OS (50F), a plurality of virtual PCs can be mounted on the server. The thin client is allocated to one virtual PC by the management server 12.

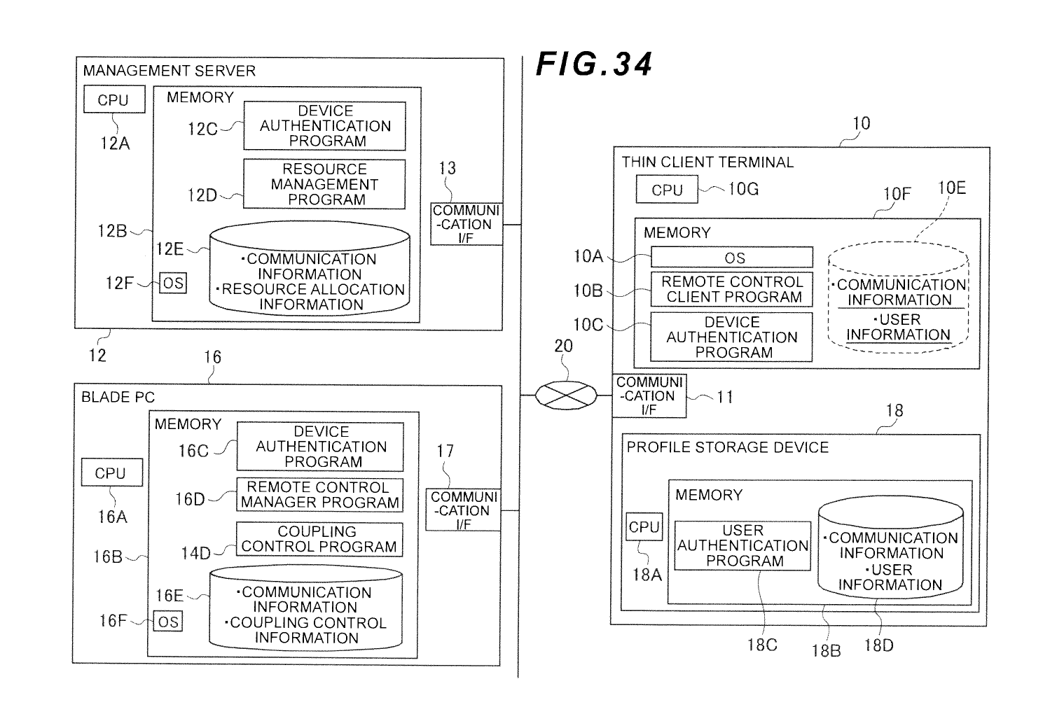

FIG. 34 shows a block diagram according to yet another embodiment of the present invention. This embodiment differs from the embodiment of FIG. 1 in that the network coupling controller has been omitted, and in substitute a coupling control program 14D for controlling the access from the thin client 10 to the blade PC has been loaded in each blade PC (16), and coupling control information 16E has been additionally stored in the memory 16B.

The processing and operation explained as the role of the network coupling controller 14 in the flowcharts and timing charts will be taken over by the respective blade PCs (16). Incidentally, since the blade PC comprises the coupling control information, the IP address of blade PC can be deleted from the coupling control information table (FIG. 8).

As shown in FIG. 1, in a mode where the network coupling controller 14 exists, the network coupling controller needed to constantly monitor the communication on the network. With the third embodiment that omitted the network coupling controller, however, the blade PC merely needs to operate the coupling control program when the thin client 10 accesses the blade PC.

The embodiments explained above are all exemplifications, and the present invention is not limited to the foregoing embodiments.

### EXPLANATION OF REFERENCE NUMERALS

10 Thin client
12 Management server
14 Network coupling controller
16 Computer resource (blade PC)
18 Profile storage device

1. A computer system, comprising:
a plurality of computer resources providing an arithmetic processing result to a thin client;
a management device deciding a prescribed computer resource from the plurality of computer resources according to a request from the thin client and allocating the decided computer resource to the thin client; and
a coupling controller restricting the thin client from coupling to a computer resource other than the decided prescribed computer resource.

2. A computer system according to claim 1,
wherein the thin client is not allowed to access the plurality of computer resources before accessing the management server, accesses the management device without accessing the plurality of computer resources, acquires access information of the prescribed computer resource that was decided by the management device, from the management device, and sends a coupling request to the prescribed computer resource based on the access information,
wherein the management device notifies identifying information of the prescribed computer resource to the thin client and the coupling controller,
wherein the coupling controller creates coupling control information from the identifying information of the prescribed computer resource, and, based on the coupling control information, maintains the coupling of the thin client and the prescribed computer resource so that the thin client is not coupled with a computer resource other than the decided computer resource, and
wherein, when the thin client notifies the management device that the coupling to the prescribed computer resource has ended, the coupling controller deletes the identifying information of the prescribed computer resource from the coupling control information and blocks the coupling from the thin client to the prescribed computer resource, the thin client comprises a connector for coupling a profile storage device containing communication information and user information, performs user authentication based on the user information when the profile storage device is coupled to the coupling connector, accesses the management device based on the communication information, copies the communication information and the user information to a memory of the thin client when the user authentication is ended, and deletes the copied information from the memory when the thin client is to end the coupling to the prescribed computer resource.

3. A computer system according to claim 1,
wherein the thin client is not allowed to access the plurality of computer resources before accessing the management server,
accesses the management device without accessing the plurality of computer resources,
acquires from the management device access information of the prescribed computer resource that was decided by the management device, and
sends a coupling request to the prescribed computer resource based on the access information.

4. A computer system according to claim 1,
wherein the management device decides the prescribed computer resource and thereafter notifies identifying information of the prescribed computer resource to the coupling controller, and
the coupling controller maintains the coupling of the thin client and the prescribed computer resource based on the identifying information of the prescribed computer resource.

5. A computer system according to claim 1,
wherein the management device notifies identifying information of the prescribed computer resource to the thin client and the coupling controller, and
wherein the coupling controller creates coupling control information from the identifying information of the prescribed computer resource, and restricts the thin client from coupling to a computer resource other than the decided computer resource based on the coupling control information.

6. A computer system according to claim 5,
wherein the coupling controller blocks the thin client from coupling to a computer resource other than the decided prescribed computer resource based on the coupling information.

7. A computer system according to claim 6,
wherein, when the thin client notifies the management device that the coupling to the prescribed computer resource has ended, the coupling controller deletes the identifying information of the prescribed computer resource from the coupling control information and blocks the coupling from the thin client to the prescribed computer resource.

8. A computer system according to claim 7,
wherein the thin client comprises a connector for coupling a profile storage device containing communication information and user information,
performs user authentication based on the user information when the profile storage device is coupled to the coupling connector, and
accesses the management device based on the communication information.

9. A computer system according to claim 8,
wherein the thin client copies the communication information and the user information to a memory of the thin client when the user authentication is ended, and deletes the copied information from the memory when the thin client is to end the coupling to the prescribed computer resource.

10. A computer system according to claim 9,
wherein the thin client notifies a user ID as the user information to the management device together with identifying information of the thin client, and
wherein the management device decides allocation of the thin client and the prescribed computer resource based on the identifying information and the user ID.

11. A computer system according to claim 1,
wherein the computer resource is a blade PC or a virtual PC mounted on a server to which the thin client is coupled.

12. A computer system according to claim 1,
wherein the coupling controller is mounted on at least one the plurality of computer resources.

13. A method of controlling a computer system for providing an arithmetic processing result from a plurality of computer resources to a thin client, comprising:
a step of deciding a prescribed computer resource from the plurality of computer resources according to a request from the thin client and allocating the decided computer resource to the thin client; and
a step of restricting the thin client from coupling to a computer resource other than the decided prescribed computer resource.

14. A management device for managing a plurality of computer resources that provide an arithmetic processing result to a thin client,
wherein the management device decides a prescribed computer resource from the plurality of computer resources according to a request from the thin client and allocates the decided computer resource to the thin client; and
wherein the management device notifies information about the allocation of a coupling controller controlling coupling between the thin client and the plurality of computer resources, and restricts the thin client from coupling to a computer resource other than the decided prescribed computer resource.
